(19) United States
(12) Patent Application Publication
(10) Pub. No.: US 2002/0156685 A1
(43) Pub. Date: Oct. 24, 2002

(54) System and method for automating electronic commerce transactions using a virtual shopping cart

(75) Inventors: Marc Alan Ehrlich, Somers, NY (US); Reiner Kraft, Gilroy, CA (US); Joann Ruvolo, San Jose, CA (US)

Correspondence Address: Samuel A. Kassatly, 6819 Trinidad Drive, San Jose, CA, 95120, US

(73) Assignee: International Business Machines Corporation

(21) Appl. No.: 09/780,636

(22) Filed: Feb. 10, 2001

(51) Int. Cl. G06F 17/60

(52) U.S. Cl. 705/26

(57) ABSTRACT

A virtual shopping cart system used in the context of an Internet environment. The system provides a shopping engine capable of searching the entire WWW to analyze an unbounded population of merchants selling a heterogeneous set of items which the shopper has placed in his or her shopping cart, enables the detection of the lowest priced instances of each item from the population of merchants, enables the sale consummation directly from the shopping cart without having to visit the merchant's site, and permits the shopper to enter into the shopping cart any item that is desired without limiting the shopper to searches on an incomplete set of items.

### CROSS-REFERENCE TO RELATED APPLICATION

This application relates to co-pending U.S. patent application, Ser. No. ______, titled “On-Line Real-Time Price Comparison and Adjustment System and Method”, which is assigned to the same assignee as the present application, which is filed concurrently with the present application, and which is incorporated herein by reference in its entirety.

### FIELD OF THE INVENTION

The present invention relates generally to electronic commerce (e-commerce) over a network, such as the Internet, for items offered on several sites. More particularly, the invention relates to a system and associated method for automating e-commerce transactions, such as the purchase of products and services on-line, wherein a virtual shopping cart is created to collect and manage transaction information across multiple independent transaction sessions from heterogeneous web sites.

### BACKGROUND OF THE INVENTION

The World Wide Web (WWW) is comprised of an expansive network of interconnected computers upon which businesses, governments, groups, and individuals throughout the world maintain inter-linked computer files known as web pages. Shoppers navigate these pages by means of computer software programs commonly known as Internet browsers. Due to the vast number of WWW sites, many web pages have a redundancy of information or share a strong likeness in either function or title. The vastness of the unstructured WWW causes shoppers to rely primarily on Internet search engines to retrieve information or to locate businesses. These search engines use various means to determine the relevance of a shopper-defined search to the information retrieved.

The authors of web pages provide information known as metadata, within the body of the hypertext markup language (HTML) document that defines the web pages. A computer software product known as a web crawler systematically accesses web pages by sequentially following hypertext links from page to page. The crawler indexes the pages for use by the search engines from information about a web page as provided by its address or Universal Resource Locator (URL), metadata, and other criteria found within the page. The crawler is run periodically to update previously stored data and to append information about newly created web pages. The information compiled by the crawler is stored in a metadata repository or database. The search engines search this repository to identify matches for the shopper-defined search rather than attempt to find matches in real time.

A typical search engine has an interface with a search window where the shopper enters an alphanumeric search expression or keywords. The search engine sifts through available web sites for the shopper's search terms, and returns the search of results in the form of HTML pages. Each search result includes a list of individual entries that have been identified by the search engine as satisfying the shopper's search expression. Each entry or “hit” may include a hyperlink that points to a Uniform Resource Locator (URL) location or web page.

Electronic shopping (or e-shopping) has been gaining popularity on the WWW. Several business models have been recommended for making e-shopping an easier and more pleasant experience to the shopper and more profitable and efficient to the vendors (or vendor sites). Generally, these models involve the creation of an information repository, typically referred to as a “shopping cart” that can be used to store transaction-related data, as a shopper browses Internet web sites and makes purchases.

For a more detailed description of various e-shopping models, reference is made to the following publications:

U.S. Pat. No. 5,745,681 to Levine et al;

U.S. Pat. No. 5,774,670 to Montulli;

U.S. Pat. No. 5,826,242 to Montulli;

U.S. Pat. No. 5,960,411 Hartman et al.; and

U.S. Pat. No. 6,101,482 to DiAngelo et al.

Once such model is based on the Java® programming language and environment that provides an open extensible framework for electronic transaction processing. This model is intended to provide a vehicle by which a shopper may organize receipts, coupons, and other electronic identification, and to provide a means by which such information may be electronically processed (along with a payment system) to effect e-commerce. A shopper of this model theoretically will be able to see all of their purchases organized in a single transaction register.

An important feature of e-shopping is price comparison for making an informed purchasing decision. A simple form of comparison shopping would be the WWW equivalent of window shopping, that is by sequentially visiting the web site of various vendors and comparing prices, clearly a time consuming and laborious task for the shopper. Moreover, sequential comparison shopping can be inaccurate in that an individual shopper may not cover all the web sites offering the desired items, potentially leading to missed shopping opportunities such as lowest price, better quality or service and so forth.

To address this shortcoming, a number or comparison shopping engines have been proposed. For example, AltaVistan® and Yahoo!® provide exemplary models of comparison shopping engines. These models are essentially search engines that allow a shopper to enter a key word (typically a description of the desired items). In response to the shopper's query, the search engines return a set of corresponding web-based matches listing the vendors or vendors' web sites that offer the desired items.

These or other services could also provide a price comparison result of each of the items corresponding to the search query. However, since these services list only those vendors that subscribe to the shopping service, the search result is not an accurate representation of the web vendors. In addition, the search engines typically search only a single item at a time, and thus shoppers must sequentially step through their shopping lists, one item at a time. As a result, the shoppers are still required to conduct numerous series of searches across an incomplete population of vendors.

The following example illustrates difficulties currently facing shoppers using conventional e-shopping services. Considering an e-shopping service that permits a shopper to fill a shopping cart with multiple heterogeneous items, such as books, music CDs, and/or movies, but still only provides access to a limited set of vendors and for a limited set of items. While this e-shopping service enables the shopper to search for multiple items in a single search, it does not provide the ability to purchase all the items in the shopping cart. Instead, the e-shopping service merely provides links to the vendors' sites so that the shoppers can link to these sites and complete the purchases, one vendor at a time.

In essence, the shopping cart of this model e-shopping service represents a shopping list that is searched to identify the best prices for the selected items. This list is incapable of implementing the check out function associated with a shopping cart, since the search result merely points or links the shopper to the vendors' web sites.

Furthermore, while the foregoing e-shopping model could provide a combined search result and an incentive for purchasing items from multiple vendors, this purpose is practically defeated because the foregoing e-shopping model does not facilitate the shopping experience. After comparison shopping, the user must still visit each of the vendors' sites separately in order to consummate the purchases from the combined result.

Accordingly, the foregoing e-shopping model, which is representative of current e-shopping services, does not adequately address the shoppers' need for an intuitive interface with the vendors' sites to complete numerous purchases from heterogeneous vendors. In particular, shoppers are not afforded the ability to search for an item from the general population of web-based vendors. Moreover, shoppers for an item are not provided with a true “shopping cart ” that permits both a price comparison of a set of heterogeneous items and the ability to purchase those items directly from the vendors. Furthermore, the scope of heterogeneous items that may be searched is limited and does not adequately address the diverse goods and/or services that shopper may wish to purchase in a single shopping excursion.

It would be highly desirable to provide a mechanism that allows shoppers to build their own “virtual shopping cart,” regardless of which shop or mall they visit on the WWW. Customers should be able to browse any store, at any time, and be able to choose an item for the cart and have any information applicable to that potential purchase retained for subsequent purchasing decisions, regardless of when that decision is made. Existing or proposed technological solutions do not provide this capability. One “brute force” solution to this problem would be to merely open up multiple instances of a browser and establish connections between the client and multiple web sites. The information “collected” in each session could then be “cut and pasted” together in a wallet and presented to the shopper for the purchasing decision. Such an approach is quite impractical because of the significant amount of processing resources that would be consumed by the opening up and maintaining of multiple browser instances. Moreover, there exists no convenient way to maintain the transaction information once the browser connections are terminated.

While U.S. Pat. No. 6,101,482 to DiAngelo et al., supra, has successfully addressed this concern, there is currently no adequate mechanism that transforms existing shopping web sites into active shopping agents, that allow shoppers to perform research about products and prices and that provide an automated buying process for all the selected items within a virtual shopping cart. The need for such an adaptive mechanism and corresponding process has heretofore remained unsatisfied.

### SUMMARY OF THE INVENTION

The system and method of the present invention for automating electronic commerce transactions using a virtual shopping cart satisfies this need. An object of the system is to automate the buying process on the WWW by providing the shoppers with a convenient way to comparison shop. The method allows the shoppers to not only compare the price of heterogeneous items, but also to purchase these items directly without having the user visit the merchants' web site.

The system provides several features and advantages among which are the following:

It provides a shopping engine capable of searching the entire WWW to analyze an unbounded population of merchants selling heterogeneous items which the shopper has placed in his or her virtual shopping cart.

It enables the detection of the lowest priced instances of each item from a very broad population of heterogeneous merchants.

It enables the sale consummation directly from the shopping cart without having to visit the merchants' web sites.

It permits the shopper to enter into the shopping cart any item that is desired without limiting the shopper to searches on a limited set of items.

Briefly, the foregoing and other features and advantages of the present invention are realized by a system and associated method for automating electronic commerce transactions using a virtual shopping cart. The system is also referred to herein as virtual shopping cart system, and is generally comprised of the following components:

A web application server, which is a web server or application manager that handles requests from clients and manages the user sessions.

A user profile manager, which maintains user account information for the virtual shopping cart web site and for various merchants' sites. This information is accessible by the user for editing purposes.

A shopping cart manager, which creates and monitors the user's virtual shopping cart.

A shopping coordinator, which performs the actual buying process of all the selected items within a shopping cart.

A comparison shopping engine, which performs comparison shopping from a plurality of heterogeneous merchants' sites. An existing web based comparison site can be used by the system of the invention to perform this function. One such web based comparison site is found at http://www.mysimon.com.

A shopping cart database, which stores the data structures necessary to manage shopping carts and associated items, i.e., the names of the stores being browsed by the shoppers, the items prices, URLS, descriptions, etc.

A user profile database, which stores the data structures necessary to manage the users' accounts, i.e., the users' credit cards accounts, passwords at various merchant stores, personal data such as home address, billing address, etc.

A merchant schema database, which contains information about merchants, their communication protocols, and how the following functions are implemented for each merchant:

Add function, that adds an item to the virtual shopping cart.

Checkout function, that guides the shopper through the check out process.

Account retrieval feature, that provides account information.

Confirm order feature, that confirms the shopper's order.

Order confirmation feature, that receives order confirmation data.

When used by current comparison shopping web-sites, the system of the present invention will transform those sites into active shopping agent sites. Shoppers will be able to use these shopping agent sites to perform research about products and prices. In addition, the method of the invention will provide an automated buying process for all selected items within a single virtual shopping cart. A shopping agent web site using the system of the invention would become a shopping portal site, satisfying all the shopping needs of the users. The system is implementable in the context of a web server that can be automatically accessed by businesses and merchants providing a comprehensive virtual shopping cart solution for internal business usage.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a virtual shopping cart system and method for automating electronic commerce transactions may be used;

FIG. 2 is a more detailed block diagram of the virtual shopping cart system of FIG. 1; and

FIG. 3 is comprised of FIGS. 3A, 3B and 3C, and illustrates a flow chart that depicts the operation of the virtual shopping cart system of FIGS. 1 and 2.

### DETAILED DESCRIPTION OF THE PREFERRED EMBODIMENTS

The following definitions and explanations provide background information pertaining to the technical field of the present invention, and are intended to facilitate the understanding of the present invention without limiting its scope:

Crawler: A program that automatically explores the World Wide Web by retrieving a document and recursively retrieving some or all the documents that are linked to it.

E-business, e-shopping, or e-commerce transactions: Business transactions conducted online using the Internet or another communications network.

Host merchant: Is the initial or original merchant whose site the shopper is currently browsing.

HTML (Hypertext Markup Language): A standard language for attaching presentation and linking attributes to informational content within documents. During a document authoring stage, HTML “tags” are embedded within the informational content of the document. When the web document (or “HTML document”) is subsequently transmitted by a web server to a web browser, the tags are interpreted by the browser and used to parse and display the document. In addition to specifying how the web browser is to display the document, HTML tags can be used to create hyperlinks to other web documents.

HTTP (Hyper Text Transfer Protocol): the protocol most often used to transfer information from World Wide Web servers to browsers.

Internet: A collection of interconnected public and private computer networks that are linked together with routers by a set of standard protocols to form a global, distributed network.

Schema: A set of grammatical rules that define the allowed structure and syntax of a document. DTD is a specific type of schema, which is used to define XML languages.

Search engine: A remotely accessible World Wide Web tool that allows shoppers to conduct keyword searches for information on the Internet.

Server: A software program or a computer that responds to requests from a web browser by returning (“serving”) web documents.

SOAP (Simple Object Access Protocol): A protocol that provides a way for applications to communicate with each other over the Internet, independent of platform, or the underlying hardware or software for a system.

URL (Uniform Resource Locator): A unique address that fully specifies the location of a content object on the Internet. The general format of a URL is protocol://server-address/path/filename.

Web browser: A software program that allows shoppers to request and read hypertext documents. The browser gives some means of viewing the contents of web documents and of navigating from one document to another.

Web document or page: A collection of data available on the World Wide web and identified by a URL. In the simplest, most common case, a web page is a file written in HTML and stored on a web server. It is possible for the server to generate pages dynamically in response to a request from the shopper. A web page can be in any format that the browser or a helper application can display. The format is transmitted as part of the headers of the response as a MIME type, e.g. “text/html”, “image/gif”. An HTML web page will typically refer to other web pages and Internet resources by including hypertext links.

Web site: A database or other collection of inter-linked hypertext documents (“web documents” or “web pages”) and associated data entities, which is accessible via a computer network, and which forms part of a larger, distributed informational system such as the WWW. In general, a web site corresponds to a particular Internet domain name, and includes the content of a particular organization. Other types of web sites may include, for example, a hypertext database of a corporate “intranet” (i.e., an internal network which uses standard Internet protocols), or a site of a hypertext system that uses document retrieval protocols other than those of the WWW.

World Wide Web (WWW also web): An Internet client-server hypertext distributed information retrieval system.

XML: eXtensible Markup Language. A standard, semi-structured language used for web documents. During a document authoring stage, XML “tags” are embedded within the informational content of the document. When the web document (or “XML document”) is subsequently transmitted by a web server to a web browser, the tags are interpreted by the browser and used to parse and display the document. In addition to specifying how the web browser is to display the document, XML tags can be used to create hyperlinks to other web documents.

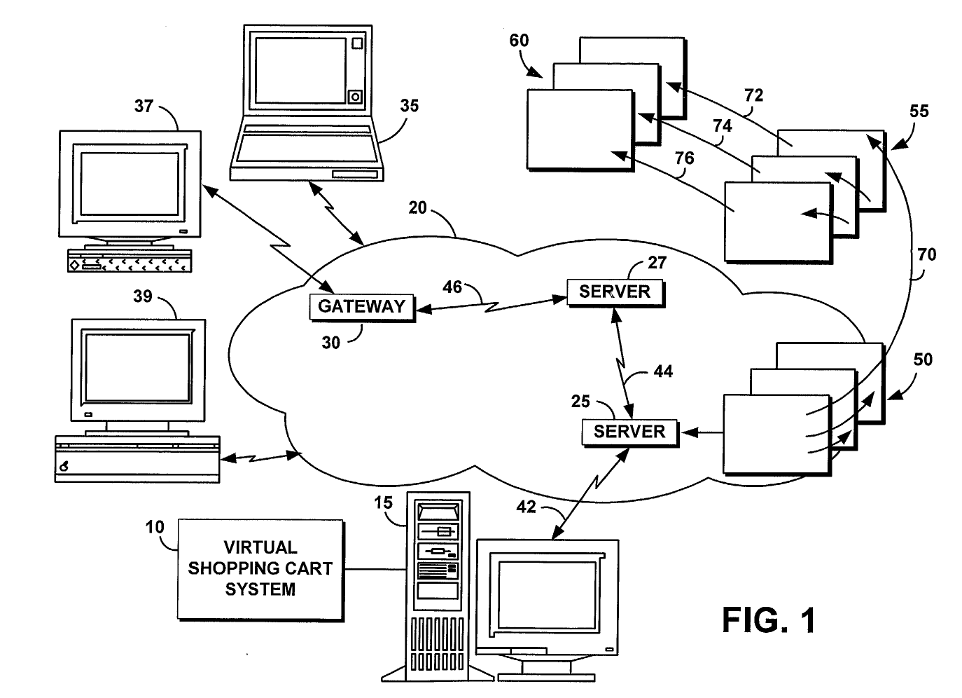

FIG. 1 portrays an overall environment in which a virtual shopping cart system 10 according to the present invention may be used. The system 10 includes a software or computer program product that is typically embedded within, or installed, at least in part, on a host server 15. Alternatively, the system 10 can be saved on a suitable storage medium such as a diskette, a CD, a hard drive, or like devices. While the system 10 will be described in connection with the WWW, the system 10 can be used with a stand-alone database of documents that may have been derived from the WWW and/or other sources.

The cloud-like communication network 20 represents for example the Internet, and is comprised of communication lines and switches connecting servers such as servers 25, 27, to gateways such as gateway 30. The servers 25, 27 and the gateway 30 provide the communication access to the Internet. Shoppers, such as remote Internet shoppers are represented by a variety of computers such as computers 35, 37, 39, and can query the host server 15 for the desired information.

The host server 15 is connected to the network 20 via a communications link such as a telephone, cable, or satellite link. The servers 25, 27 can be connected via high speed Internet network lines 44, 46 to other computers and gateways. The servers 25, 27 provide access to stored information such as hypertext or web documents indicated generally at 50, 55, and 60. The hypertext documents 50, 55, 60 most likely include embedded hypertext link to other locally stored pages, and hypertext links 70, 72, 74, 76 to other webs sites or documents 55, 60 that are stored by various web servers such as the server 27.

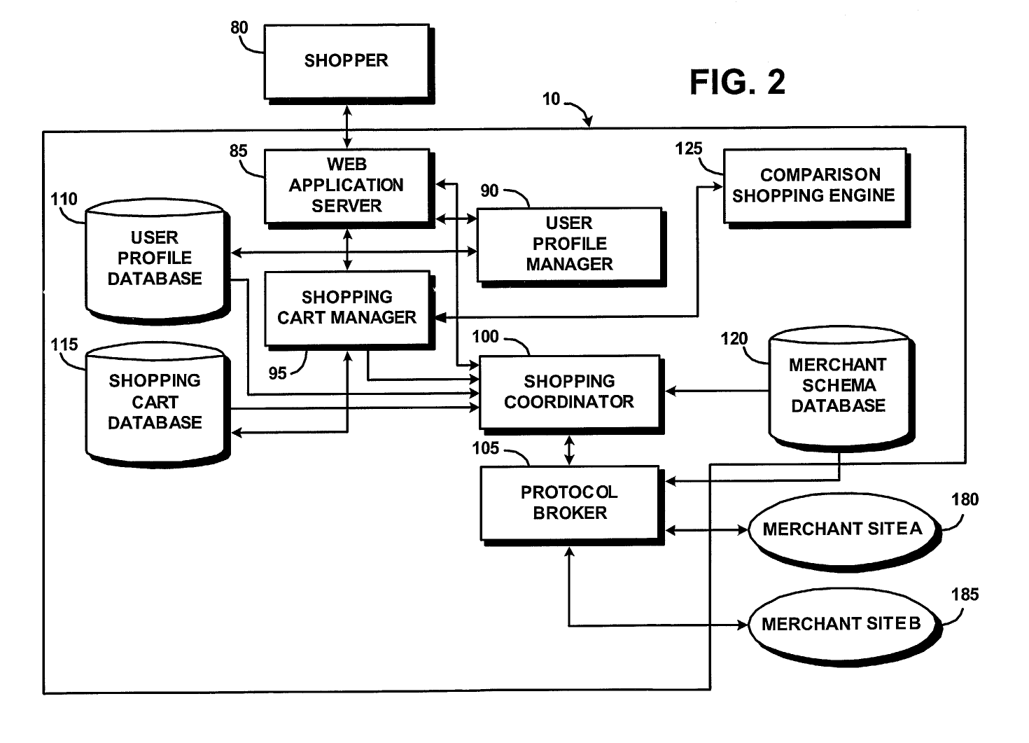

FIG. 2 illustrates an exemplary architecture depicting the virtual shopping cart system 10 used in the context of an Internet environment by a shopper 80. The system 10 is comprised of a web application server 85, a user profile manager 90, a shopping cart manager 95, a shopping coordinator 100, a protocol broker 105, and a comparison shopping engine 125. Three databases are used to store data required by the virtual shopping cart system: a user profile database 110, a shopping cart database 115, and a merchant schema database 120.

To use the virtual shopping cart system 10, the shopper 80 registers with the server 15 and obtains a user ID and a password. In addition, the shopper 80 provides the server 15 with address and credit card account information and any other relevant account passwords the shopper 80 may have with various Internet merchants of choice. Typically, a user establishes an account with an Internet merchant before the user can purchase items from that merchant. At a minimum, the merchant usually requires a user ID, an e-mail address, and an associated password. This user information is maintained by the user profile manager 90 and stored in the user profile database 110. The shopper 80 may revise information in the user profile database 110 by accessing the user profile manager 90 through the web application server 85.

The shopper 80 accesses the system 10 through the web application server 85, which can be a standard web server (or application server) component, such as Microsoft®) IIS 5.0 or IBM® WebSphere® that is capable of handling HTTP requests from clients and managing user sessions. The web application server 85 communicates with the user (or shopper) profile manager 90 that maintains the user profile, and also with the shopping coordinator 100 that monitors the current user's virtual shopping cart.

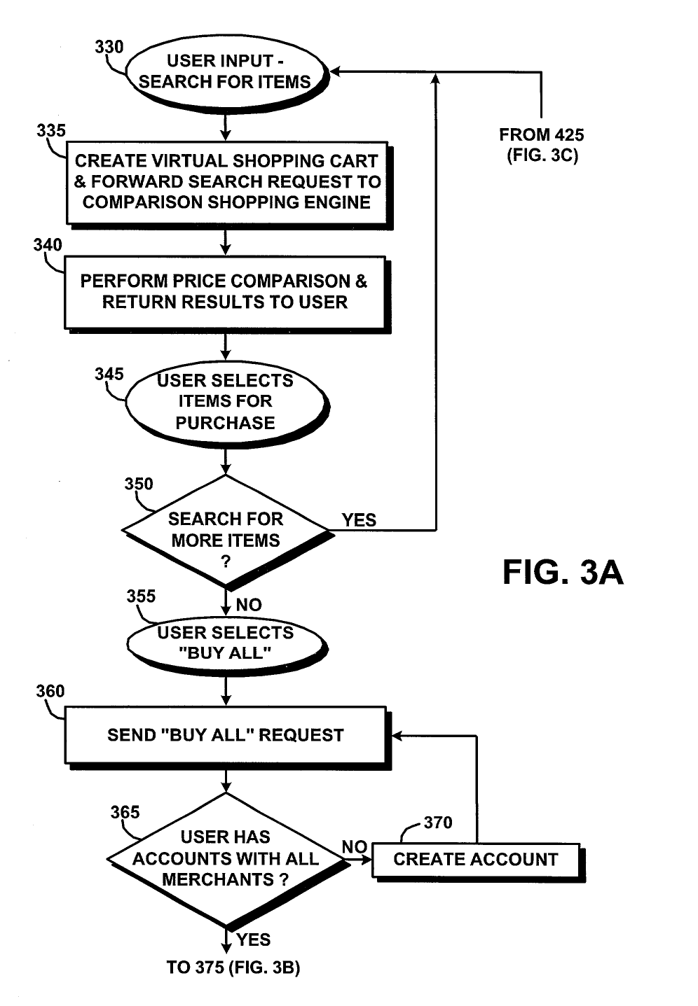

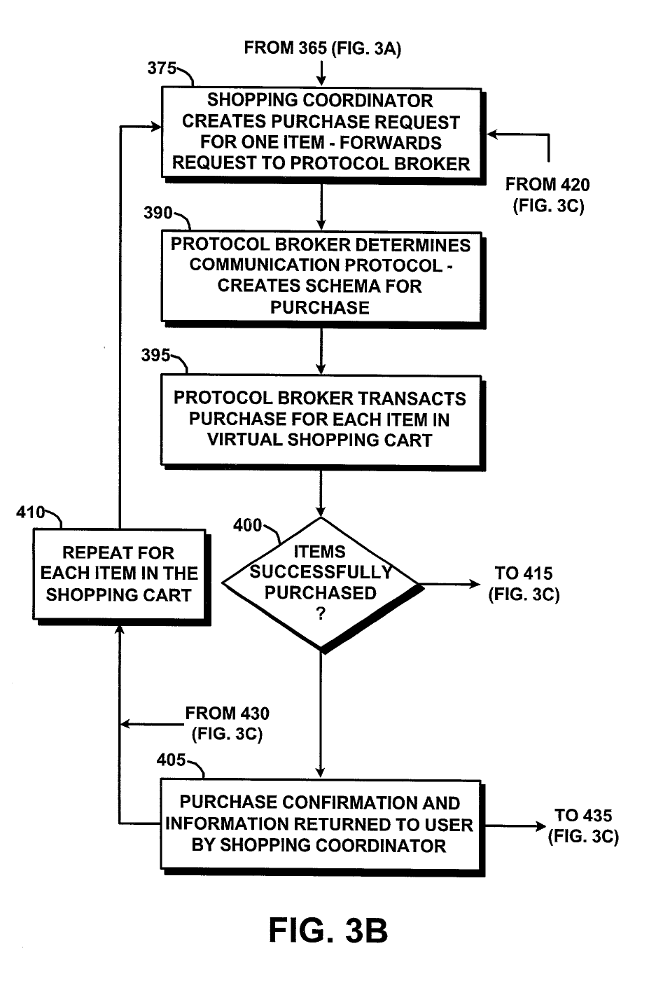

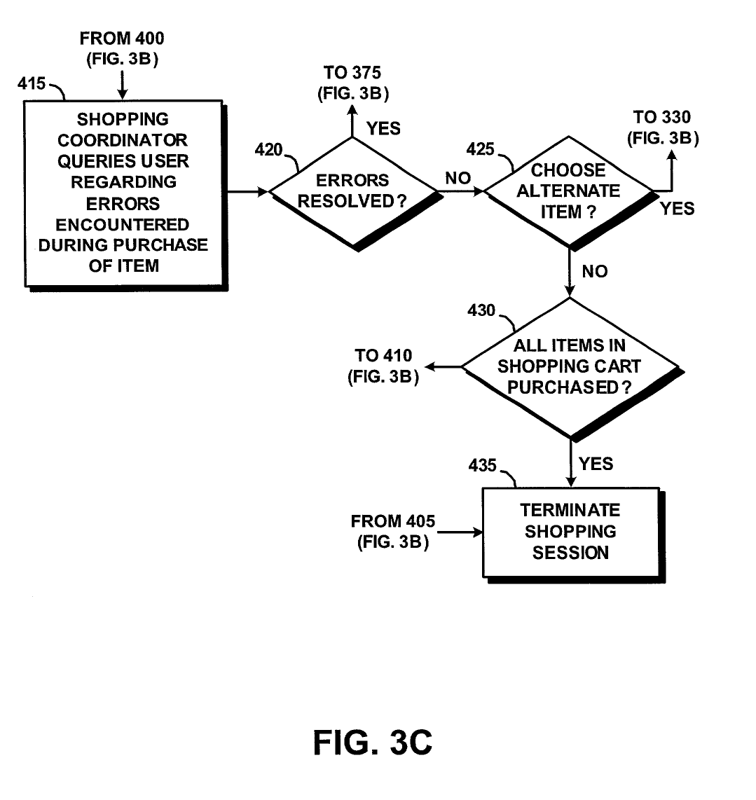

In operation, and with further reference to FIG. 3 (FIGS. 3A, 3B, 3C), and the shopper 80 typically starts the shopping method 300 at step 330 by searching for a particular item. For each shopping session, the shopping cart manager 95 creates a virtual shopping cart at step 335, and stores the information in the shopping cart database 115. The shopper's search request is forwarded at step 335 by the shopping cart manager 95 to the comparison shopping engine 125.

At step 340, the comparison shopping engine 125 performs comparison shopping from a plurality of heterogeneous merchant sites (i.e. 180, 185), and returns the search results to the shopper 80 through the web application server 85. Existing web-based comparison shopping sites, for example at http://www.mysimon.com, can be used to perform the comparison shopping function. The comparison shopping engine 125 may communicate with the other components of the system 10 using a standard protocol such as HTTP or recent technologies such as SOAP (Simple Object Access Protocol) which is based on XML. A comparison shopping engine implemented as a SOAP server would allow convenient integration with the system 10 as a SOAP client.

At step 345, the shopper 80 is now able to select an item from the results presented by the web application server 85 and “ADD” the item to the virtual shopping cart. This “ADD” request is sent to the shopping cart manager 95 which stores the necessary information such as the session ID, item URL, price, merchant, etc. in the shopping cart database 115.

Typically, the shopping cart exists for the duration of the shopper's session with the virtual shopping cart system 10 and is not stored long term. The shopper 80 may remove or update items from the virtual shopping cart using REMOVE or UPDATE requests, search for additional items, select from the search results presented by the web application server 85, and add them to the virtual shopping cart at step 350.

After completing the necessary iterations of steps 330 to 350, the shopping cart contains several items that may have been selected from one or more merchants 180, 185. The ability to purchase items from a plethora of merchants in one shopping session represents an important improvement over existing e-commerce shopping carts where a user may only select and purchase items from one merchant at a time.

The shopping coordinator 100 of FIG. 2 executes the purchase of items in the virtual shopping cart. Upon receiving a “BUY ALL” request at step 360 along with a session ID from the shopping cart manager 95, the shopping coordinator 100 is able to retrieve the contents of the shopping cart from the shopping cart database 115. The shopping coordinator 100 also retrieves, from the user profile database 110, the user information required to purchase items from each individual merchant represented in the virtual shopping cart, and checks, at step 365, whether the shopper 80 has accounts with those merchants.

If the shopper 80 does not have an account with any of the merchants, the shopping coordinator 100 prompts the shopper 80 at step 370 for information required for an account with the merchant. Alternatively, the shopping coordinator 100 could send the shopper 80 to the merchant's web site to register with the merchant directly. The shopper 80 would then provide this merchant account information to the virtual shopping cart system 10 before proceeding with the purchase process.

In another embodiment of the system 10, the shopper 80 would have an account already established with the host of the system 10. In this case, the system 10 would act as an agent, interacting with merchants in its own name and charging the shopper 80 for the costs.

With reference to FIG. 3B, and at step 375, the shopping coordinator 100 creates a purchase request for each item of the virtual shopping cart and forwards these requests to the protocol broker 105 using, for example, SOAP as the communication protocol. To proceed with the purchase of items in the virtual shopping cart, the protocol broker 105 communicates with each merchant web site represented in FIG. 2, for example, as merchant site A (180) and merchant site B (185), by using the merchant's preferred protocol. Each merchant might use a different protocol such as HTTP, SMTP, or SOAP. Therefore, the protocol broker 105 translates the SOAP protocol used by the shopping coordinator 100 into a purchase request that the merchant can understand.

Information on communication requirements for each merchant is stored in the merchant schema database 120. With the advent of UDDI (Universal Description, Discovery and Integration) such a merchant schema database could be implemented as a UDDI service. The overall goal of UDDI is to facilitate e-commerce, by providing a directory service for business methods and web services. A web service could automatically query UDDI to discover what purchasing services to buy a specific product or service are available, and how to access them (e.g. technical fingerprint, protocol, wire format, specification etc.). At step 390 of FIG. 3, the protocol broker 105 parses and analyzes the purchase request to retrieve the corresponding merchant protocol data from the merchant schema database 120. The protocol broker 105 then chooses for each purchase request, the most appropriate protocol and communication mode. The current protocol of choice used for web browser based shopping is HTTP, and the specifications for items available for purchase are encoded in HTML documents. This will change probably over the next few years with web services (based on WSDL) and SOAP, with the integration of UDDI as mentioned above. It should however be clear that other suitable protocols can be used as they become available.

When a user purchases an item directly from a merchant via the Internet, the buy request is submitted using an HTTP POST or GET. The web server of the merchant communicates with its merchant server, which then performs the credit card check, determines availability of items, etc. The interaction that would normally take place between the user and the merchant is preferably performed by the virtual shopping cart system 10. For each merchant, the system 10 creates a communication schema at step 390 before a shopping transaction can be performed.

The shopping coordinator 100 ensures support for several shopping functions, among which are the following:

add an item to a shopping cart;

proceed to check out;

provide account information, including payment options;

confirm and place order; and

receive order confirmation data.

For each of these functions, the protocol broker 105 assigns a protocol and creates an appropriate schema. The system 10 stores the required protocol along with a communication schema template that has place holders for the item ID, the session ID, etc. During the purchase request, the protocol broker 105 replaces the place holders with the actual values or items required by the merchant for the purchase of the specific item requested by the virtual shopping cart system 10.

The protocol broker 105 transacts a separate purchase at step 395 of FIG. 3 for each item in the virtual shopping cart using the schemas created at step 390. The shopping coordinator 100 waits for purchase confirmation from the protocol broker 105 for each purchase request in decision step 400.

If the item was successfully purchased in decision step 400, the shopping coordinator 100 processes the shopper's credit card for the purchase amount, notifies the shopper 80 that the purchase was completed, and provides to the shopper 80 any purchase information such as confirmation numbers, shipping information, etc. at step 405.

The shopping coordinator 100 then proceeds to the next item as shown by step 410 in the virtual shopping cart, and repeats steps 375 through 405. If a transaction could not be completed for any reason, the shopping coordinator 100 interacts with the shopper 80 at step 415 (FIG. 3C) to resolve the error. If the errors with the merchant can be resolved, the shopping coordinator 100 will reinstate the purchase request for that transaction at step 375.

If the error cannot be resolved, the shopper 80 may need to select an alternate item at step 425 (FIG. 3C), which takes the shopper 80 back to step 330 to add another item to the virtual shopping cart. If the shopper 80 does not choose to select an alternate item at step 425 and additional items are left in the virtual shopping cart, the shopping coordinator 100 then continues with the purchase process and repeats steps 375 through 405 for those items. Otherwise, the shopping session is terminated at step 435 (FIG. 3C).

The following example is considered with reference to FIGS. 2 and 3 to elucidate the operation and performance of the virtual shopping cart system 10. The shopper 80 logs onto the system 10 by providing a user ID and password then enters a search request for a book titled “Professional Active Server Pages 3.0” (step 330). The shopping cart manager 95 creates a virtual shopping cart in the shopping cart database 115 and assigns a session ID to the shopping cart. The shopping cart manager 95 then forwards the search request to the comparison shopping engine 125 (step 335). The comparison shopping engine 125 returns the following results in Table I, below to the shopper 80 (step 340) via the web application server 85, where Table I provides exemplary results of a search by the comparison shopping engine 125 for the book “Professional Active Server Pages 3.0”:

TABLE I

| Store Name | Availability | Price |
|---|---|---|
| Buy.com ® | In Stock | $44.99 |
| Powells.com | In Stock | $59.99 |
| BarnesandNoble.com ® | In Stock | $47.99 |
| Amazon.com ® | In Stock | $47.99 |
| Borders.com ® | In Stock | $50.99 |
| Booksamillion.com ® | In Stock | $43.19 |
| Bigwords.com | In Stock | $39.38 |
| Fatbrain.com ® | In Stock | $47.95 |
| A1Books.com | In Stock | $38.95 |
| VarsityBooks.com | In Stock | $53.99 |
| SoftproSoftwareandBooks.com | In Stock | $59.99 |
| WordsWorthBooks | In Stock | $53.99 |
| Bookpool | In Stock | $41.50 |

The shopper 80 selects the merchant A1Books.com and the shopping cart manager 95 enters the following information in the virtual shopping cart (step 345):

| | |
|---|---|
| Item: | 01 |
| Session ID: | 123 |
| Item URL: | http://www.a1books.com/cgi- |
| | bin/a1books/a1Front?act=showDesc&WVSESSION_ID= |
| | 3885&ISBN=1861002610 |
| Item Name: | Professional Active Server 3.0 |
| Price: | $38.95 |
| Category: | Book |
| ID: | 1851002610 |

The shopper 80 now requests another search for the book titled “Bee Season” (step 350). The shopping cart manager 95 forwards this search request to the comparison shopping engine 125 (step 335) and the comparison shopping engine 125 returns the following results in Table II below, to the shopper 80 (step 340) via the web application server 85, where Table II provides exemplary results of a search by the comparison shopping engine 125 for the book “Bee Season”:

TABLE II

| Store Name | Availability | Price |
|---|---|---|
| buy.com ® | In Stock | $15.99 |
| Powells.com | In Stock | $22.95 |
| BarnesandNoble.com ® | In Stock | $18.36 |
| Amazon.com ® | In Stock | $18.36 |
| Borders.com ® | In Stock | $17.21 |
| Booksamillion.com ® | In Stock | $14.45 |
| Bigwords.com | In Stock | $16.33 |
| SeekBooks.com | In Stock | $16.58 |
| Soft4u.com ® | In Stock | $19.49 |
| Countrybookshop.com | In Stock | $30.00 |
| Fatbrain.com ® | In Stock | $22.95 |
| A1Books.com | In Stock | $16.25 |
| VarsityBooks.com | In Stock | $20.66 |
| WordsWorthBooks | In Stock | $19.51 |

The shopper 80 selects the merchant Booksamilion.com® and the shopping cart manager 95 enters the following information in the virtual shopping cart (step 345):

| | |
|---|---|
| Item: | 02 |
| Session ID: | 123 |
| Item URL: | http://www.booksamillion.com/ncom/books?id= |
| | 9713063048202&pid=0385498799 |
| Item Name: | Bee Season |
| Price: | $14.45 |
| Category: | Book |
| ID: | 0385498799 |

Next, the shopper 80 requests a new search for the toy “Deluxe Start Action Factory” by Rokenbok® (step 350). The shopping cart manager 95 forwards this search request to the comparison shopping engine 125 (step 335) and the comparison shopping engine 125 returns the following results in Table III below, to the shopper 80 (step 340) via the web application server 85, where Table III provides exemplary results of a search by the comparison shopping engine 125 for the toy “Deluxe Start Action Factory” by Rokenbok®”:

TABLE III

| Store Name | Availability | Price |
|---|---|---|
| amazon.com ® | 3 days | $179.99 |
| SacToys.com | In Stock | $169.99 |
| LaToys.com | 5 days | $152.99 |
| IQKids.com | 3 days | $179.99 |
| Rokenbok.com | In Stock | $179.99 |

The shopper 80 selects the merchant SacToys.com and the shopping cart manager 95 enters the following information in the virtual shopping cart (step 345):

| | |
|---|---|
| Item: | 03 |
| Session ID: | 123 |
| Item URL: | http://sactoys.com/detail.asp?SKU=34120&Page=5 |
| Item Name: | Rokenbok ® System Deluxe Start Action Factory |
| Price: | $169.99 |
| Category: | Toy |
| ID: | 34120 |

The virtual shopping cart now contains 3 different items from 3 different merchants. The item URL for each item contains the merchant and item information. The shopper 80 may now delete one or more of the items in the virtual shopping cart, continue searching for items to purchase, or purchase ail the items in the shopping cart. The shopper 80 chooses to “BUY ALL” (step 355) and the shopping cart manager sends a “BUY ALL” request to the shopping coordinator 100 and the protocol broker 105.

Using the session ID, the shopping coordinator 100 retrieves the contents of the shopping cart from the shopping cart database 115 (step 360). With the user's ID, the shopping coordinator 100 retrieves the user's merchant account information from the user profile database 110 (step 365), and finds that the shopper 80 has an account with Booksamillion.com® and A1Books.com, but not with LaToys.com. The shopping coordinator 100 (step 370) prompts the shopper 80 for the information required by LaToys.com to set up an account: e-mail address, password, etc. The shopping coordinator 100 now creates a purchase request for each item in the virtual shopping cart (step 375) and forwards these requests to the protocol broker 105 using SOAP. The SOAP request for item number 01 is:

M-POST /cgi-bin/purchase-book.cgi HTTP/1.1

Man: “http://www.microsoft.com/protocols/ext/SOAP”; ns=01

01-MethodName: PurchaseBook

01-InterfaceName: soap:cdl:com.develop.purchase_book

01-MessageType: Call

Content-Type: text/xml-soap

<PurchaseBook>

<ISDN>1861002610</ISBN>

<Title>Professional Active Server Pages 3.0</Title>

<Merchant>A1Books.com</Merchant>

<Item_URL>http://www.a1books.com/cgi-bin/a1books/a1Front?act=showDesc&WVSESSION_ID=3885&ISBN=18 61002610</Item_URL>

</PurchaseBook>

The protocol broker 105 analyzes and parses the SOAP purchase request, retrieves the merchant protocol data for A1Books.com from the merchant schema database 120, and creates the set of schemas required for the purchase process (step 390). Each item in the virtual shopping cart requires a separate transaction by the protocol broker 105 (step 395). The protocol broker 105 sends a purchase confirmation to the shopping coordinator 100 when the book “Professional Active Server Pages 3.0” is purchased (step 400).

The shopping coordinator 100 then charges the user's credit cart for the amount of the purchase and provides the confirmation number, shipping information, etc for the book to the shopper 80 (step 405). The shopping coordinator has the option of charging for each item individually, or alternatively, it can simultaneously charge for all the items purchased during the shopping session. Steps 175 through 205 are repeated for each item in the shopping cart. When all 3 items in the shopping cart are purchased, the shopping session is terminated at step 435.

It is to be understood that the specific embodiments of the invention that have been described are merely illustrative of certain applications of the principle of the present invention. Numerous modifications may be made to the system and method for automating electronic commerce transactions using a virtual shopping cart described herein without departing from the spirit and scope of the present invention. Moreover, while the present invention is described for illustration purpose only in relation to the WWW, it should be clear that the invention is applicable as well to any device that stores data in fields.

What is claimed is:

1. A system for automating an electronic-commerce transaction using a virtual shopping cart initiated at a host site, comprising:
a user profile database that stores data structures necessary to manage a plurality of users' accounts;
a merchant schema database that contains information about schemas used by a plurality of heterogeneous merchants' sites;
a shopping cart manager that creates the virtual shopping cart based on a user's search query, and that monitors the content of the virtual shopping cart; and
a comparison shopping engine that collects and manages information across multiple independent transaction sessions from the plurality of heterogeneous merchants' sites, based on the user's search query, and that returns a corresponding comparative search result, without requiring the user to leave the host site to visit the plurality of heterogeneous merchants' sites.

2. The system of claim 1, further including a shopping coordinator that executes a desired shopping request for at least one item in the virtual shopping cart.

3. The system of claim 2, further including a protocol broker module that communicates with at least one of the plurality of heterogeneous merchants' sites using at least one of the schemas in the merchant schema database.

4. The system of claim 3, further including a user profile manager that maintains the user profile database and the merchant schema database.

5. The system of claim 4, further including a shopping cart database that stores a plurality of data structures necessary to manage a plurality of shopping carts and items contained in the plurality of shopping carts.

6. The system of claim 5, wherein the merchant schema database contains information about the plurality of merchants, their communication protocols, and how any one or more of the following functions are implemented for each merchant:
add function, that adds an item to the virtual shopping cart;
checkout function, that guides the shopper through a check out process;
account retrieval feature, that provides account information;
confirm order feature, that confirms a shopper's order;
order confirmation feature, that receives order confirmation data.

7. The system of claim 5, wherein the protocol broker parses and analyzes the shopping request related to an item in the virtual shopping cart, to retrieve a corresponding merchant protocol from the merchant schema database.

8. The system of claim 7, wherein the corresponding merchant protocol is HTTP, and information related to the item in the virtual shopping cart is encoded, at least in part, in HTML.

9. A shopping agent site for automating an electronic-commerce transaction using a virtual shopping cart initiated at a host site, comprising:
a user profile database that stores data structures necessary to manage a plurality of users' accounts;
a merchant schema database that contains information about schemas used by a plurality of heterogeneous merchants' sites;
a shopping cart manager that creates the virtual shopping cart based on a user's search query, and that monitors the content of the virtual shopping cart; and
a comparison shopping engine that collects and manages information across multiple independent transaction sessions from the plurality of heterogeneous merchants' sites, based on the user's search query, and that returns a corresponding comparative search result, without requiring the user to leave the host site to visit the plurality of heterogeneous merchants' sites.

10. The shopping agent site of claim 9, further including:
a shopping coordinator that executes a desired shopping request for at least one item in the virtual shopping cart; and
a protocol broker module that communicates with at least one of the plurality of heterogeneous merchants' sites using at least one of the schemas in the merchant schema database.

11. A method of automating an electronic-commerce transaction using a virtual shopping cart initiated at a host site, comprising:
storing a plurality of data structures necessary to manage a plurality of users' accounts;
storing information about a plurality of schemas used by a plurality of heterogeneous merchants' sites;
creating the virtual shopping cart based on a user's search query;
monitoring the content of the virtual shopping cart; and
collecting and managing information across multiple independent transaction sessions from the plurality of heterogeneous merchants' sites, based on the user's search query, and returning a corresponding comparative search result, without requiring the user to leave the host site to visit the plurality of heterogeneous merchants' sites.

12. The method of claim 11, further including executing a desired shopping request for at least one item in the virtual shopping cart.

13. The method of claim 12, further including communicating with at least one of the plurality of heterogeneous merchants' sites using at least one of the schemas in the merchant schema database.

14. The method of claim 13, further including maintaining the plurality of data structures necessary and the plurality of schemas.

15. The method of claim 14, further including storing a plurality of data structures necessary to manage a plurality of shopping carts and items contained in the plurality of shopping carts.

16. The method of claim 15, wherein storing information about the plurality of schemas includes storing information about the plurality of merchants, their communication protocols, and how any one or more of the following functions are implemented for each merchant:
add function, that adds an item to the virtual shopping cart;
checkout function, that guides the shopper through a check out process;
account retrieval feature, that provides account information;
confirm order feature, that confirms a shopper's order;
order confirmation feature, that receives order confirmation data.

17. The method of claim 15, wherein collecting and managing information includes parsing and analyzing the shopping request related to an item in the virtual shopping cart, to retrieve a corresponding merchant protocol.

18. A computer program product for automating an electronic-commerce transaction using a virtual shopping cart initiated at a host site, comprising:
a user profile database that stores data structures necessary to manage a plurality of users' accounts;
a merchant schema database that contains information about schemas used by a plurality of heterogeneous merchants' sites;
a shopping cart manager that creates the virtual shopping cart based on a user's search query, and that monitors the content of the virtual shopping cart; and
a comparison shopping engine that collects and manages information across multiple independent transaction sessions from the plurality of heterogeneous merchants' sites, based on the user's search query, and that returns a corresponding comparative search result, without requiring the user to leave the host site to visit the plurality of heterogeneous merchants' sites.

19. The computer product of claim 18, further including a shopping coordinator that executes a desired shopping request for at least one item in the virtual shopping cart.

20. The computer program product of claim 19, further including a protocol broker module that communicates with at least one of the plurality of heterogeneous merchants' sites using at least one of the schemas in the merchant schema database.
